(19) United States
(12) Patent Application Publication
(10) Pub. No.: US 2009/0277841 A1
(43) Pub. Date: Nov. 12, 2009

(54) METHOD FOR MINIMIZING CORROSION, SCALE, AND WATER CONSUMPTION IN COOLING TOWER SYSTEMS

(76) Inventors: Donald A. Johnson, Batavia, IL (US); Arthur J. Kahaian, Chicago, IL (US)

Correspondence Address: Edward O. Yonter;Patent and Licencing Department, Nalco Company, 1601 West Diehl Road, Naperville, IL, 60563-1198, US

(21) Appl. No.: 12/116,677

(22) Filed: May 7, 2008

(51) Int. Cl. C02F 9/00; C02F 1/42

(52) U.S. Cl. 210/668; 210/739; 210/663; 210/743; 210/746; 210/670; 210/143

(57) ABSTRACT

This invention is an improved process for operation of evaporative recirculating cooling systems. In addition to reducing the scaling and corrosive tendencies of the water, the method eliminates or reduces discharge from the system without creating any localized corrosive or scaling conditions as a result of the treatment process. The described measurement and control system generally comprises an array of measurements, a means of implementing control logic, and an array of control actions including activating an ion exchange device to treat makeup water. The measurements can include of physical measurements of flow rates, chemical measurements of water composition, and performance-related metrics such as water corrosiveness or scaling tendency. Preferably, the measurements include one or more of pH, conductivity, hardness, alkalinity, corrosiveness, scaling tendency, treatment additive dosage level, and treatment additive residual of the makeup, treated makeup, and recirculating water.

### TECHNICAL FIELD

This invention relates generally to methods of monitoring and controlling corrosion, scale, and water consumption in evaporative recirculating cooling water systems. More specifically, the invention relates to methods of monitoring and controlling such characteristics via exposing the makeup water stream to an ion exchange device. The invention has particular relevance to automated methods.

### BACKGROUND

The open recirculating cooling water system is a widely used process for rejection of waste heat from a variety of processes. A perfectly efficient open recirculating system would utilize all the makeup water for evaporative cooling, and would have no blowdown stream. In reality no system achieves this level of efficiency. Water losses always occur, whether inadvertent such as those created by loss of entrained water from a cooling tower (drift) or from leaks. In addition, controlled removal or “blowdown” from the tower also takes place, which is necessary to limit the accumulation of dissolved species that cause scaling and/or corrosion of system components.

Chemical additives are injected into the system to reduce the deleterious effects of scaling, corrosion, and microbiological activity of the recirculating water. These additives are normally added at a rate needed to maintain a relatively constant concentration in the recirculating water. The required dosage is determined by the treatment intensity needed to meet the conditions created by the chemical, physical, and microbiological environment of the recirculating water. To achieve that end, the rate of addition is typically controlled to replace the amount of the additives consumed within the recirculating system and that are removed with the blowdown stream. Consequently, a reduction of the flow of the blowdown stream reduces the injection rate of treatment chemicals needed to maintain the required dosage.

The use of water treatment processes to remove dissolved species from makeup water is known and described in the literature. These processes encompass the range of known methods, and include filtration, precipitation, and membrane and ion exchange methods, each of which produces water with different characteristics. However, it is not necessary or even desirable to removal all the dissolved species from the makeup water. The solubility of the various potential scaling minerals varies widely, and some dissolved species contribute to corrosion inhibition. Fully purified water is quite corrosive and difficult to treat. The ideal pretreatment process would reduce or eliminate problem components and maintain or enhance desirable ones.

From a water composition perspective, a cooling tower system with makeup pretreatment consists of three zones of conditions: (i) raw water prior to the pretreatment unit; (ii) treated makeup water prior to blending with the concentrated tower water; and (iii) blended and concentrated tower water. The raw water has the composition of the source water, the treated makeup has a composition defined by the characteristics of the pretreatment process, and the blended tower water is defined by the overall operation of the cooling tower system. These streams can have large volumetric flow rates and may be in contact with engineered materials that are susceptible to corrosion damage, such as ferrous, galvanized, or copper alloy. It is often impractical to replace these large conduits with corrosion resistant materials, thus making important management of the corrosiveness of water in each of the three zones.

In comparing cooling systems with and without pretreatment processes, it is important to include the operational requirements of the pretreatment system in the overall consideration of the operation of the cooling system. For example, even though inclusion of a pretreatment operation may allow reduction or elimination of blowdown from a cooling system, the pretreatment operation may have its own blowdown requirements that can partially or completely offset the water savings benefits realized by the cooling tower. Most pretreatment operations require treatment and/or regenerant chemicals for their continued operation.

The prior art of this field largely consists of the operation of cooling systems with makeup water treated precipitation processes such as lime softening, membrane processes such as reverse osmosis, and ion exchange processes. As a large category, precipitation processes are well known and widely practiced. Compared to the process of this invention are large operations, which require carefully controlled addition of softening chemicals, produce large volumes of solid waste, and often produce unstable, scale-forming water. Membrane processes, particularly those employing reverse osmosis are also known in the art to be used for cooling water makeup pretreatment. Membrane processes, however, are subject to scaling and fouling, requiring blowdown often in excess of what would be required by a cooling tower using untreated makeup water. Reverse osmosis processes produce water of high purity. This high purity water has the advantage of being low in corrosive ions. Inhibitive ions are also removed, and when used in cooling systems, this high purity water is typically quite corrosive and difficult to treat. As will be described later, the process of the present invention overcomes the limitations of these two broad categories of prior art.

There are many ion exchange processes known to the prior art. Collectively, they involve cation, anion, or combination exchange processes. Cation and anion exchange resins are further subdivided into strong and weak acid cation and strong and weak base anion categories (The Nalco Water Handbook, 1998, 2-12 “Ion Exchange”, McGraw-Hill, 1998). Some of these processes have been employed for cooling water makeup pretreatment. A well-known and widely practiced method of makeup water treatment for cooling towers is the use of sodium-cycle softening for hardness removal (J. P. Wetherell and N. D. Fahrer, Recent Developments in the Operation of Cooling Tower Systems with Zero Blowdown, Cooling Tower Institute, TP-89-13, 1989). That process involves passing raw water through a strong acid cation (“SAC”) ion exchange column charged with sodium ions. The water produced by the process has nearly complete replacement of the hardness (e.g., Ca⁺², Mg⁺²) with sodium, rendering the water non-scaling with respect to calcium scales such as CaCO₃ and others. The anion content of the water remains unchanged. When applied to cooling tower makeup treatment, this approach suffers from some limitations and deficiencies. Since corrosive anions (e.g., Cl⁻, SO₄⁻²) are not removed from the makeup, they can concentrate to problematic levels in the cooling tower.

Furthermore, the corrosivity of natural waters to carbon steel is strongly influenced by the ratio of corrosive to inhibitive (e.g., CO₃⁻²) species in the water (T. E., Larson and R. V. Skold, Laboratory Studies Relating Mineral Quality of Water to Corrosion of Steel and Cast Iron, 1958 Illinois State Water Survey, Champaign, Ill. pp. [43]-46: ill. ISWS C-71). If the ratio is not favorable in the source water, the treatment process will not improve it. Another deficiency is the large excess of brine (typically three times the absorbed hardness) required to regenerate the resin, can generate a significant discharge problem. A variant on this process is described in U.S. Pat. No. 6,929,749 B2 to Duke, which employs high levels of silicate (>200 mg/l SiO₂) and elevated pH (>9.0) to control corrosion.

The use of weak acid dealkalization is a well-known treatment approach for boiler feedwater treatment. It has also been employed as a means of cooling water makeup pretreatment (see U.S. Pat. Nos. 6,746,609 to Stander and 4,532,045 to Littmann. This process involves passing raw water through a column containing weak acid cation exchange resin (“WAC”) in the hydrogen or protonated form. The carbonate and bicarbonate ions in the raw water are able to abstract hydrogen ions from the weak base resin, converting the carbonate and bicarbonate to carbonic acid (i.e., H₂CO₃) and creating charged sites on the resin. The charged sites then absorb cations with a preference for divalent hardness ions. The water produced by the process is slightly acidic with a pH of 3.5 to 6.5 (depending on the degree of exhaustion of the column) and has the hardness reduced in proportion to the removal of alkalinity. Upon exhaustion, the ion exchange column is regenerated with a strong acid. An advantage of the use of WAC resin is that the regeneration is more efficient, with less excess regenerant required.

The water produced by that process is quite corrosive to many common materials of construction, and the processes disclosed in U.S. Pat. Nos. 5,730,879 to Wilding; 6,746,609 to Stander; and 4,931,187 to Derham teach methods for controlled bypass of the dealkalizer systems to achieve a desired pH and alkalinity in the cooling tower. However, the water remains very corrosive to metals in the area between the treatment unit and the cooling tower where blending occurs. Wilding, Stander, and U.S. Pat. No. 5,703,879 to Baumann also describe the use of strong acid cation exchangers for this purpose.

The use of anion exchange resins to treat cooling system makeup has also been described. U.S. Pat. Nos. 5,820,763 to Fujita and 5,985,152 to Otaka, and JP 6-158364 describe a process consisting of passing makeup water through a strong base anion exchange (“SBA”) resin charged with bicarbonate. The exchange process removes corrosive chloride and sulfate ions and replacing them with inhibitive bicarbonate ions, reducing the corrosivity of the water. Upon exhaustion, the resin is regenerated with a bicarbonate salt such as sodium bicarbonate. The selectivity of the resin for Cl⁻ and SO₄⁻² creates a need for a large excess of sodium bicarbonate for regeneration.

There thus exists a need for improved processes to remove scaling and corrosive tendencies from the water in recirculating cooling water systems. Of particular importance, is to provide methods of treating the water to produce an ideal mixture of ionic constituents so as not to require addition of makeup water or excessive blowdown.

### SUMMARY

This disclosure accordingly describes an improved process for operation of cooling tower systems. In addition to reducing the scaling and corrosive tendencies of the water, the method further eliminates or reduces discharge or “blowdown” without creating any localized corrosive or scaling conditions as a result of the treatment process. The described measurement and control system generally comprises an array of measurements, a means of implementing control logic, and an array of control actions. The measurements can consist of physical measurements of flow rates, chemical measurements of water composition, and performance-related metrics such as water corrosiveness or scaling tendency. Preferably, the measurements include one or more of pH, conductivity, hardness, alkalinity, corrosiveness, scaling tendency, treatment additive dosage level, and treatment additive residual of the makeup, treated makeup, and recirculating water.

In a preferred aspect, the invention includes a process for operation of a cooling system that reduces the scaling and corrosion potential within the system. These potentials are reduced in both makeup water and after degassing and concentration in a cooling system, which overcomes a prominent deficiency of the prior art. In addition, the invention describes means of adjusting the process in order to optimize the properties of both the raw and concentrated water streams, and a means of minimizing blowdown or discharge from the cooling system.

In an embodiment, the invention is a method of monitoring and controlling an evaporative recirculating cooling water system. The system typically includes components such as a recirculated water stream, a makeup water source, and a makeup water stream. The method includes a means for reducing hardness and alkalinity in the makeup water stream; a means for reducing the corrosiveness of the makeup water stream after reducing the hardness and alkalinity; a means for measuring a chemical composition and/or performance characteristics of the makeup water source, the makeup water stream, and/or the recirculated water stream; a means for determining whether the measured chemical composition and/or performance characteristic(s) fall within an optimum range; and a means for adjusting one or more operating parameters of the system.

In another aspect, the invention is a method of monitoring and controlling an evaporative recirculating cooling water system. The system typically includes components such as a recirculated water stream, a makeup water source, a makeup water stream, an optional additive source, and a controller in communication with at least one of the components. While the system is under operating conditions, the method includes measuring one or more characteristics of the recirculated water stream, the makeup water stream, and/or the makeup water source. The measured characteristics are then transmitted to the controller that, in turn, determines whether the measured characteristic(s) meet preselected criteria. If the measured characteristic(s) do not meet the preselected criteria, the controller is operable to perform at least one of the following functions: (i) activating one or more devices operable to contact the makeup water stream from the makeup water source with an ion exchange material, wherein the ion exchange material is operable to adjust a subset of the measured characteristic(s); (ii) optionally activating the additive source to introduce one or more additives into the evaporative recirculating cooling water system; and (iii) optionally activating one or more control actions.

In a further aspect, the invention is an apparatus for operating an evaporative recirculating cooling water system, where the system generally includes components such as a recirculated water stream, a makeup water source, a makeup water stream, and a controller. In communication with the controller is a monitoring device operable to monitor one or more characteristics of the recirculated water stream, the makeup water stream, and/or the makeup water source. A transmitting device in communication with the controller is operable to transmit the measured characteristic(s) from the monitoring device to the controller. The controller is operable to execute instructions to determine whether the measured characteristic(s) meet preselected criteria and is operable to initiate transmission of instructions or data to any component or device in the system. A receiving device is also in communication with the controller and is likewise operable to receive transmitted instructions or data from any component or device in the system.

According to a preferred embodiment, the invention includes an ion exchange device that is in communication with the controller. The ion exchange device includes an ion exchange material and is capable of being activated via transmitted instructions received from the controller to contact the makeup water stream with the ion exchange material. The ion exchange material is chosen to enable adjustment of a subset of the characteristic(s). The characteristic(s) may also be adjusted via an optional additive source that is operable to adjust one or more additive levels in the recirculated cooling water stream.

The invention further includes optional mechanisms for additional control actions. Representative control actions include controlling a blowdown circuit; adjusting raw water bypass flow into the system; adjusting additive injection into the system or removal from the system; adjusting CO₂ or other carbonic species addition or removal from the system; blending raw water with makeup water; adjusting dosage of scale, corrosion, and/or biocontrol additives via the additive source; and combinations thereof.

It is an advantage of the invention to provide an apparatus and method of achieving efficient and reliable operation of cooling systems.

It is another advantage of the invention to overcome limitations of the prior art through more efficient water usage in cooling systems.

A further advantage of the invention is to provide an apparatus and method for reducing the corrosion and scaling tendency of the water in cooling systems.

Yet another advantage of the invention is to reduce discharge of treatment chemicals with the blowdown stream in cooling systems.

Additional features and advantages are described herein, and will be apparent from, the following Detailed Description, Figures, and Examples.

### BRIEF DESCRIPTION OF THE DRAWINGS

FIG. 1 illustrates a schematic of a typical evaporative recirculating cooling water system.

FIG. 2 is a schematic representing a preferred embodiment of the invention.

FIG. 3 shows an example of water characteristics produced at various phases by the method of the invention.

FIG. 4 illustrates another embodiment of the invention including a recycle stream, bypass stream, and alkalinity source.

### DETAILED DESCRIPTION

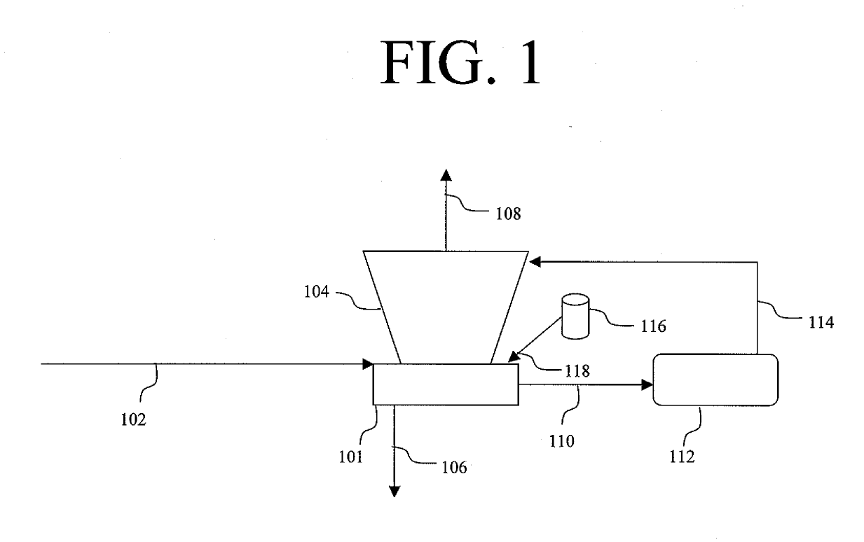

Referring to the Figures, typical elements of an evaporative recirculating cooling system are depicted in the schematic of FIG. 1. Cooling system 100 includes makeup water stream 102, which is connected to a makeup source (not shown). Collection basin 101 functionally includes heat rejection device 104 (collectively, “cooling unit”), blowdown circuit 106, conduit 110 that feeds heat exchanger 112, recirculative conduit 114, treatment additive injector 116, and additive injection point 118. Evaporative loss 108 of recirculating water occurs through heat rejection device 104.

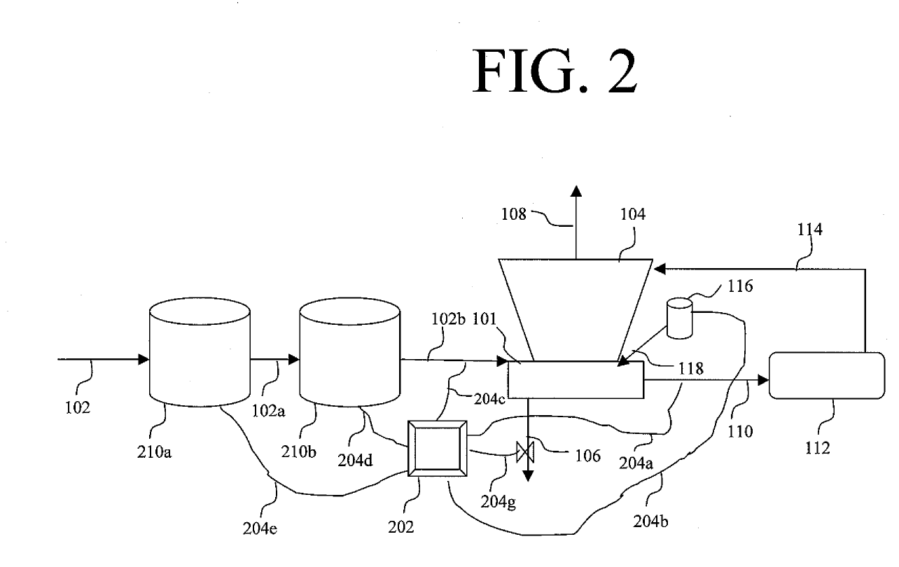

FIG. 2 is a schematic of a preferred embodiment of the invention. Cooling system 200 includes the components described above for cooling system 100 with additional components operable to execute the described method and comprise the described apparatus of the invention. Controller 202 is in direct or indirect communication (shown with dotted lines 204a to 204g). It should be appreciated that such communication among any of the described components may communicate via a wired network, a local area network, wide area network, wireless network, internet connection, microwave link, infrared link, and the like.

“Controller, “controller system,” and similar terms refer to a manual operator or an electronic device having components such as a processor, memory device, cathode ray tube, liquid crystal display, plasma display, touch screen, or other monitor, and/or other components. In certain instances, the controller may be operable for integration with one or more application-specific integrated circuits, programs, or algorithms, one or more hard-wired devices, and/or one or more mechanical devices. Some or all of the controller system functions may be at a central location, such as a network server, for communication over a hard-wired network, local area network, wide area network, wireless network, internet connection, microwave link, infrared link, and the like. In addition, other components such as a signal conditioner or system monitor may be included to facilitate signal-processing algorithms.

In one embodiment, the control scheme is automated. In another embodiment, the control scheme is manual or semi-manual, where an operator interprets the signals. Such means of implementing control logic may be any device capable of receiving and interpreting an array of input data from the system, determining appropriate control actions, and communicating them to a control actuator. Preferably, the array of available control actions has the capability of adjusting the operation of the previously described elements of the system to achieve the desired water chemistry and characteristics. Representative operational adjustments include but are not limited to controlling a blowdown circuit; adjusting raw water bypass flow into the system; adjusting additive injection into the system or removal from the system; adjusting CO₂ or other carbonic species addition or removal from the system; blending raw water with makeup water; adjusting dosage of scale, corrosion, and/or biocontrol additives via the additive source; and combinations thereof.

FIG. 2 further illustrates ion exchange devices 210a and 210b (sometimes collectively referred to as ion exchange device 210). According to this embodiment, makeup water stream 102 is first treated by ion exchange device 210a to produce reduced hardness and alkalinity stream 102a. Stream 102a is then treated by ion exchange device 210b to reduce to produce reduces corrosiveness stream 102b. According to alternative embodiments, cooling water system 200 may include one, two, or more ion exchange devices. Ion exchange device 210 preferably includes at least one type of ion exchange material that is operable to adjust a subset of the measured characteristic(s) of the makeup water stream. Representative ion exchange materials include a cation exchange material, a weak acid cation exchange material, an anion exchange material, a weak base anion exchange material, and combinations thereof. Such materials are well known in the art. Controller 202 is operable to activate ion exchange device 210 (including 210a and/or 210b) to contact makeup water stream 102 with the ion exchange material.

A preferred means for reduction of hardness and alkalinity in the makeup water stream is an ion exchange system, optionally including a means of regeneration. More preferably, it is an ion exchange system containing a cation exchange material, with a means for regeneration into the protonated form. Most preferably, it is an ion exchange system containing weak acid cation exchange medium with means for regeneration to the acid form.

The means for the reduction of water corrosiveness is preferably a system that increases the pH of the water. More preferably, it is an anion exchange system containing absorbed inhibitive materials to decrease the corrosiveness and which are capable of absorbing corrosive anions. Most preferably, it is an ion exchange system containing a weak base anion exchanger with means for regeneration.

The foregoing may be better understood by reference to the following examples, which are intended for illustrative purposes and are not intended to limit the scope of the invention.

### EXAMPLE 1

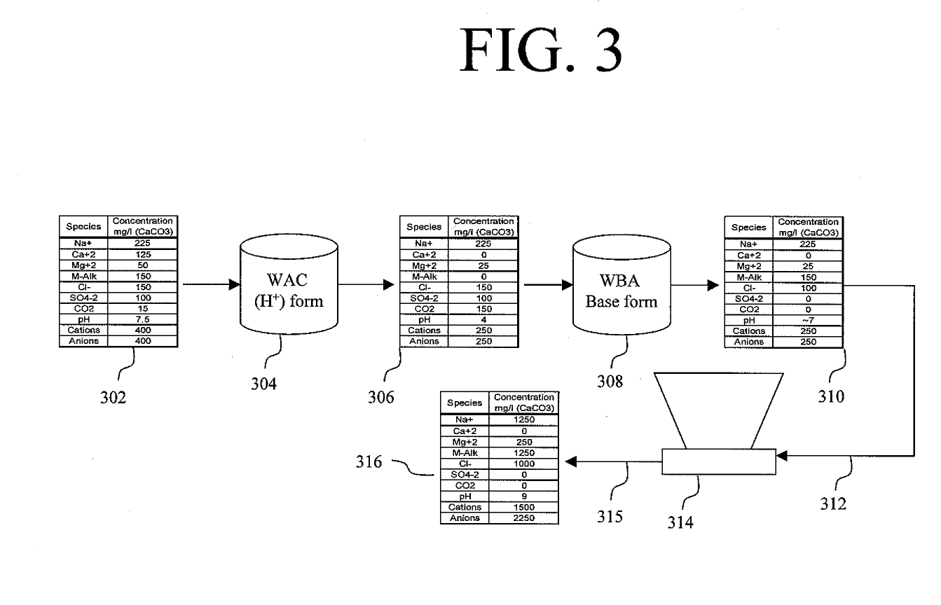

FIG. 3 represents a prophetic example of the water characteristics produced various phases of the invention. Flowchart 300 shows a typical pathway for the changing water characteristics along various points in the evaporative recirculating cooling system. Table 302 represents the composition of typical raw source water that would be used for cooling system makeup. The raw water is passed through column 304, which contains weak acid (carboxylic acid functionalized) cation (“WAC”) exchange resin that has been put into the H⁺ or protonated form by exposure to acid regenerant. Because of the relatively weak acidity of the carboxylic acid functional groups, the resin has little to no ion exchange capacity unless the hydrogen ions are removed by a species acting as a base. The alkalinity (HCO₃⁻, and CO₃⁻²) of the raw water serves that purpose by reacting with the carboxylic acid functional groups and producing CO₂ and the carboxylate form of the ion exchange resin. Once the resin is charged by such deprotonation, it absorbs cationic solutes from the makeup water. The carboxylate resin typically has selectivity to cations in the order of Ca²⁺>Mg⁺²>>Na⁺.

The net result of this process is the intermediate water composition shown in Table 306, which contains high levels of CO₂, and a small amount of mineral acid leakage from WAC column 304. It typically has a pH in the range from 3.5 to 5.5, and is expected to be highly corrosive to ferrous and yellow metals commonly used in water lines. Water as represented by Table 306, produced by exposure to WAC column 304 is processed by a means for corrosivity reduction. In this example, column 308 containing weak base anion (“WBA”) resin in the free base form. WBA resins are water-insoluble ion exchange materials, which are functionalized with weakly basic groups, typically primary or secondary amines. In the free base form, the resins are uncharged and have minimal ion exchange capacity. The free base form of the WBA resin reacts with the dissolved carbon dioxide and mineral acid content of water having composition represented by Table 306, whereupon absorbing a proton, acquiring cationic charge, and leaving the dissolved CO₂ largely in the form of bicarbonate (HCO₃⁻). Upon protonation, the WBA resin acquires anion exchange capacity and absorbs anions. The order of absorption preference for the anions present in the example is SO₄⁻²>>Cl>HCO₃⁻. A typical composition of water from this process is shown in Table 310.

As demonstrated in later examples, the water produced by the WBA treatment has low enough corrosivity to be transmitted through corrosion-susceptible transmission line or conduit 312 to cooling unit 314 (cooling unit 314 includes the collection basin and the heat rejection device as in FIG. 1). Through the processes of degasification, evaporation and concentration (10 times in this example) the water achieves the composition shown in Table 316, which is a favorable composition for corrosion and scale control.

### EXAMPLE 2

Optimal water chemistry for corrosion and scale control may require an increase or decrease in the total hardness of the makeup water (see T. E., Larson and R. V. Skold, Laboratory Studies Relating Mineral Quality of Water to Corrosion of Steel and Cast Iron, 1958 Illinois State Water Survey, Champaign, Ill. pp. [43]-46. ill. ISWS C-71). According to the invention, this situation will be detected by the measurement and control system and may be actuated by any of the following control actions or combinations of actions. A decrease in the blowdown rate (via blowdown circuit 315 of cooling unit 314) will increase the concentration of all the dissolved species in the makeup water, whereas, an increase will decrease the concentrations. However, because increased blowdown decreases the efficiency of cooling system operation, this may not be the most desirable action.

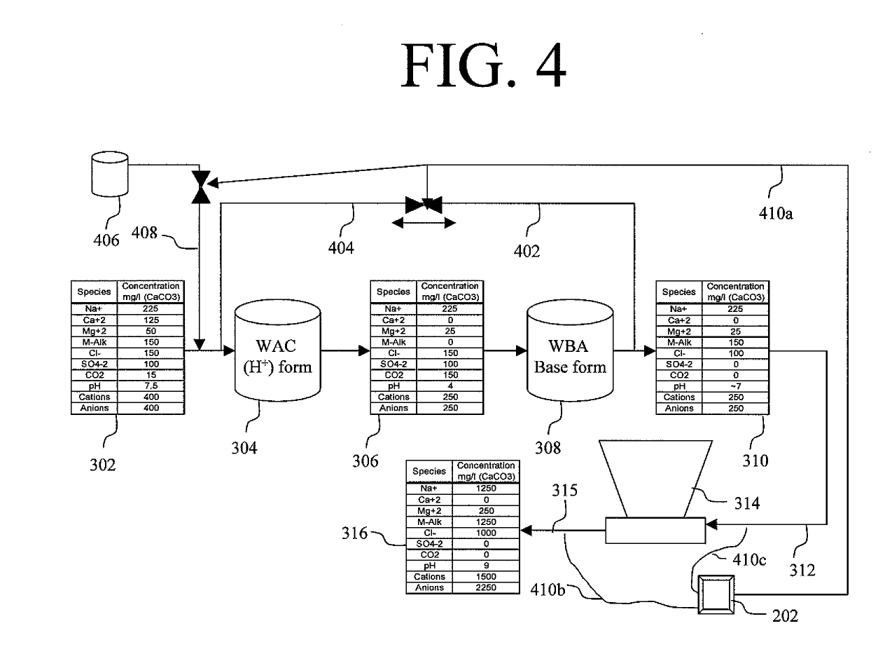

Referring to FIG. 4, hardness can also be increased in the system by partial bypass stream 402. If a hardness reduction is required, an appropriate control action would be to activate recycle stream 404 and blend it with the incoming raw water, effectively increasing the ratio of alkalinity to total hardness and thereby increasing the efficiency of WAC column 304. The hardness removal of WAC column 304 may also be increased by supplementary injection from alkalinity source 406, which provides, for example, sodium carbonate or bicarbonate, prior to WAC column 304 through injection conduit 408. In a preferred embodiment, controller 202 is in communication with various system components through communication links 410a, 410b, and 410c. It should be appreciated the controller 202 may include one, two, or any suitable number of such communication links with system components.

### EXAMPLE 3

Natural water supplies have variable solute compositions. Of particular importance to cooling system treatment is the ratio of corrosion inhibitive to corrosion-promoting ions. To maintain a range of desirable water composition in the cooling system while still giving efficient operation of the softening plant (i.e., WAC column), the measurement and control system of the invention is operable to adjust to variations in this ratio. Because of the principles explained in Example 1, the operation of the WBA anion exchanger is also particularly important for this objective. The ion exchange action of the WBA resin is actuated by dissolved CO₂, which is a product of the interaction of the alkalinity of the raw water with the WAC column. If the concentration of alkalinity is less than that of the aggressive ions, the removal of aggressive ions (e.g., Cl⁻ and SO₄⁻²) may be insufficient. Conversely, if the alkalinity of the raw water is greater than the concentration of aggressive ions, some of the anion exchange capacity will be used to absorb bicarbonate, which is a desirable species for corrosion control. According to the invention, one of the control actions is the removal or addition of CO₂ by injection or stripping after the WAC column and prior to the WBA column.

### EXAMPLE 4

Corrosion testing was done on copper and mild steel coupons with Naperville, Ill. City water (Lake Michigan) in three conditions: (i) raw, as drawn from the tap, (ii) WAC treated, and (iii) WAC/WBA treated. The coupons were exposed overnight to each of the three water compositions. Results are shown in Table 1. It was observed that the raw water was moderately corrosive to carbon steel, the WAC-treated water severely so, and WAC/WBA water much less so.

TABLE 1

| Species | | | |
|---|---|---|---|
| (mg/l CaCO₃) | Raw Water | WAC | WAC/WBA |
| Ca | 89 | 2 | 6 |
| Mg | 46 | 1.7 | 8.2 |
| Na | 116 | 16 | 22 |
| M Alkalinity | 100 | −53 | 40 |
| Cl | 21 | 15 | 0.83 |
| SO₄ | 30 | 29 | 0.21 |
| pH | 8.1 | 3.2 | 8.1 |
| Conductivity (μS/cm) | 300 | 300 | 74 |
| Corrosion (mil/yr) | 9.7 | 96 | 3.7 |
| (mild steel) | | | |
| Corrosion (mil/yr) | — | 9.8 | 2.2 |
| (Copper) | | | |

### EXAMPLE 5

This example illustrates a deficiency of the prior art. U.S. Pat. Nos. 4,532,045 to Littman and 6,746,609 to Stander suggest that the blending of WAC-treated and raw water can provide acceptable control of corrosion. However, the data from Table 2 indicates that such is not the case. Table 2 shows various blends of treated and raw water and their corrosiveness as measured by dissolved metal ions in the test solution. Even an 80/20 vol % blend of raw/treated water has significantly increased corrosiveness to copper, steel, brass and galvanized steel.

TABLE 2

| | | | Mild Steel | Copper | Brass | | Galvanized | |
|---|---|---|---|---|---|---|---|---|
| | | | Coupon | Coupon | Coupon | | Coupon | |
| | WAC | | Species (mg/ml) | | | | | |
| Raw % | % | pH | Fe | Cu | Cu | Zn | Zn | Fe |
| 100 | 0 | 7.81 | 0.42 | 0.84 | 0.37 | 0.62 | 0.1 | 0.16 |
| 80 | 20 | 6.57 | 2.2 | 12.6 | 9.9 | 9.2 | 0.11 | 8 |
| 60 | 40 | 5.64 | 10.1 | 6.5 | 3.8 | 8.8 | 0.5 | 7.2 |
| 40 | 60 | 4.96 | 15.3 | 2.2 | 0.75 | 10.4 | 0.5 | 11.8 |
| 20 | 80 | 4.33 | 21.25 | 4 | 1.3 | 14.25 | 1 | 15.5 |
| 0 | 100 | 3.66 | 48.5 | 10 | 2 | 16 | 1 | 23.25 |

### EXAMPLE 6

An example of a control action according to the invention is the recycling and blending of treated water with raw water to increase the removal of hardness and anions. The removal of hardness by a WAC material is typically in proportion to the amount of alkalinity present in the water. If the alkalinity is less than the total hardness, only a portion of the total hardness will generally be removed. By recycling the treated water to a point before the WAC column, the alkalinity and hardness of the blended water can be more closely balanced and the extent of hardness removal increased. Data from this process is shown in Table 3. The second pass was a 2/1 ratio of raw water to recycled water to approximately balance total hardness and Ca.

TABLE 3

| | | | | | | Blended |
|---|---|---|---|---|---|---|
| Species | Raw | | Cation/ | Blended | Blended | Cation/ |
| (mg/l CaCO₃) | Water | Cation | Anion | Raw | Cation | Anion |
| Ca | 180 | 36 | 57 | 130 | 16 | 18 |
| Mg | 83 | 45 | 44 | 68 | 27 | 30 |
| Na | 170 | 170 | 170 | 150 | 150 | 140 |
| Cl | 170 | 170 | 130 | 160 | 160 | 130 |
| SO₄ | 85 | 84 | 0.95 | 57 | 57 | 0.35 |
| M Alkalinity | 160 | −28 | 130 | 140 | −21 | 70 |
| pH | 8.4 | 3.5 | 7.8 | 8.1 | 3.2 | 7.4 |
| Conductivity | 830 | 650 | 530 | 710 | 540 | 430 |
| (μS/cm) | | | | | | |

### EXAMPLE 7

It is well known that raw water sources value widely in solute composition (Nalco Water Handbook, “Ion Exchange,” Pp. 2 to 12, 1998). This Example illustrates a control action that enables the method of the invention to adapt to such varying water compositions. The control action includes adding alkaline or acidic additives to the raw water prior to exposure to the WAC column to decrease or increase the extent of hardness removal. Acidic species may include one or more strong acids, such as sulfuric, hydrochloric, nitric, organic, and the like. Alkaline species may include alkali metal or alkaline earth metal carbonates, bicarbonates, or hydroxides.

Results in Table 4 illustrate the effect of adding sodium bicarbonate prior to the softening process. The first three columns show typical alkalinity-deficient water and the results of the step of the WAC/WBA process. The last three columns show the effect of the addition of 80 ppm (as CaCO₃) of sodium bicarbonate. A dramatic improvement in both hardness and corrosive ion removal was observed.

TABLE 4

| | | | | | Enhanced | Enhanced |
|---|---|---|---|---|---|---|
| Species | Raw | | WAC/ | | Alkalinity | Alkalinity |
| (mg/l CaCO₃) | Water | WAC | WBA | Raw + NaHCO₃ | WAC | WAC/WBA |
| Ca | 180 | 36 | 57 | 180 | 11 | 13 |
| Mg | 83 | 45 | 44 | 87 | 9 | 12 |
| Na | 170 | 170 | 170 | 270 | 250 | 240 |
| Cl | 170 | 170 | 130 | 170 | 170 | 63 |
| SO₄ | 85 | 84 | 1 | 88 | 90 | 4.5 |
| M Alkalinity | 170 | −28 | 130 | 250 | −33 | 190 |
| pH | 84 | 3.5 | 7.8 | 8.4 | 4.2 | 7.8 |
| Conductivity | 830 | 650 | 530 | 970 | 620 | 480 |
| (μS/cm) | | | | | | |

### EXAMPLE 8

Variable water quality and desired final composition of cooling tower water makes it desirable to control the efficiency of both the WAC and WBA columns/ion exchange materials. The removal of corrosive ions and subsequent alkalinity enhancement by the WBA column is typically controlled by dissolved CO₂ produced by the WAC column. Another control action of the invention is the addition of removal of CO₂ to achieve the desired control action. Results in Table 5 illustrate this effect. The first three columns show the treatment effect produced by the CO₂ naturally produced by the WAC column. The final four columns illustrate the effect of adding or removing CO₂. Through such a control action, it is possible to adjust the ratio of inhibitive to corrosive ion, thereby controlling the corrosiveness of the water produced by the process. In Table 5′ NC means “Native CO₂”; DC means “Decarbonated”; and FC means “Fully Carbonated.”

TABLE 5

| Species | | | WAC/ | | | WAC/ | WAC/ |
|---|---|---|---|---|---|---|---|
| (mg/l | Raw | WAC | WBA | WAC | WAC | WBA | WBA |
| CaCO₃) | Water | NC | NC | DC | FC | DC | FC |
| Ca | 180 | 11 | 13 | 6.3 | 3.7 | 7 | 3.9 |
| Mg | 83 | 9 | 12 | 5.5 | 10 | 6.5 | 9.8 |
| Na | 270 | 250 | 240 | 260 | 290 | 280 | 280 |
| Cl | 170 | 170 | 63 | 180 | 180 | 200 | 43 |
| SO₄ | 88 | 90 | 4.5 | 91 | 93 | 15 | 0.52 |
| M Alkalinity | 250 | −33 | 190 | −10 | −10 | 63 | 230 |
| pH | 8.4 | 4.2 | 7.8 | 6.7 | 4.6 | 9.7 | 6.1 |
| Cond. | 970 | 620 | 480 | 640 | 670 | 640 | 530 |
| (μS/cm) | | | | | | | |

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

The claimed invention is:

1. A method of monitoring and controlling an evaporative recirculating cooling water system, wherein said system includes components comprising a recirculated water stream, a makeup water source, and a makeup water stream, the method comprising:
(a) a means for reducing hardness and alkalinity in the makeup water stream;
(b) a means for reducing the corrosiveness of the makeup water stream after treatment by the means of step (a);
(c) a means for measuring a chemical composition and/or performance characteristics of the makeup water source, the makeup water stream, and/or the recirculated water stream;
(d) a means for determining whether the measured chemical composition and/or performance characteristic(s) fall within an optimum range; and
(e) a means for adjusting one or more operating parameters of the system.

2. The method of claim 1, wherein the means for reducing hardness and alkalinity in the makeup water stream includes an ion exchange device.

3. The method of claim 1, wherein the means for measuring the chemical composition and/or performance characteristic(s) of the makeup water source, the makeup water stream, and/or performance characteristics fall with the optimum range includes one or more sensors in communication with a controller.

4. The method of claim 1, wherein the chemical composition and/or performance characteristic(s) are selected from the group consisting of: pH, conductivity, hardness, alkalinity, corrosiveness, scaling tendency, and combinations thereof.

5. A method of monitoring and controlling an evaporative recirculating cooling water system, wherein said system includes components comprising a recirculated water stream, a makeup water source, a makeup water stream, an optional additive source, and a controller in communication with at least one of the components, the method comprising:
(a) operating the evaporative recirculating cooling water system;
(b) measuring one or more characteristics of the recirculated water stream, the makeup water stream, and/or the makeup water source;
(c) transmitting the measured characteristic(s) to the controller;
(d) determining whether the measured characteristic(s) meet a preselected criteria; and
(e) if the measured characteristic(s) do not meet the preselected criteria:
(i) activating one or more devices operable to contact the makeup water stream from the makeup water source with an ion exchange material, wherein the ion exchange material is operable to adjust a subset of the measured characteristic(s),
(ii) optionally activating the additive source to introduce one or more additives into the evaporative recirculating cooling water system, and
(iii) optionally activating one or more control actions.

6. The method of claim 5, including a means to regenerate the ion exchange material when an ion exchange capacity of said material has been reduced.

7. The method of claim 5, including a plurality of different ion exchange materials, each ion exchange material capable of being individually contacted with the makeup water stream.

8. The method of claim 5, wherein the ion exchange material is selected from the group consisting of: a cation exchange material; a weak acid cation exchange material; an anion exchange material; a weak base anion exchange material; and combinations thereof.

9. The method of claim 5, wherein the control action(s) is selected from the group consisting of: controlling a blowdown circuit; adjusting raw water bypass flow into the system; adjusting additive injection into the system or removal from the system; adjusting CO₂ or other carbonic species addition or removal from the system; blending raw water with makeup water; adjusting dosage of scale, corrosion, and/or biocontrol additives via the additive source; and combinations thereof.

10. The method of claim 5, including operating the method over a network, wherein the network includes one or more sensors, additional controllers, digital storage mediums, and/or communication means.

11. The method of claim 10, wherein the network is an Internet.

12. A digital storage medium having computer-executable instructions stored thereon, the instructions operable to execute the method of claim 1.

13. An apparatus for operating an evaporative recirculating cooling water system, wherein said system includes components comprising a recirculated water stream, a makeup water source, a makeup water stream, and a controller, the apparatus comprising:
(a) a monitoring device in communication with the controller, the monitoring device operable to measure one or more characteristics of the recirculated water stream, the makeup water stream, and/or the makeup water source;
(b) a transmitting device in communication with the controller and operable to transmit the measured characteristic(s) from the monitoring device to the controller, the controller operable to execute instructions to determine whether the measured characteristic(s) meet preselected criteria and operable to initiate transmission of instructions or data to any component or device in the system;
(c) a receiving device in communication with the controller and operable to receive transmitted instructions or data from any component or device in the system;
(d) an ion exchange device in communication with the controller, the ion exchange device including an ion exchange material and capable of being activated via transmitted instructions received from the controller to contact the makeup water stream with the ion exchange material, wherein the ion exchange device is operable to adjust a subset of the characteristic(s);
(e) optionally an additive source operable to adjust one or more additive levels in the recirculated cooling water stream; and
(f) optionally one or more mechanisms for activating one or more control actions.

14. The apparatus of claim 13, wherein the ion exchange device includes a plurality of different ion exchange materials, each material capable of being individually activated and contacted with the makeup water stream.
